(19) United States
(12) Patent Application Publication
(10) Pub. No.: US 2011/0281522 A1
(43) Pub. Date: Nov. 17, 2011

(54) TRACTOR TRAILER DATA COMMUNICATION APPARATUS AND METHOD

(76) Inventor: Raymond Anthony Suda, Sterling Heights, MI (US)

(21) Appl. No.: 13/014,766

(22) Filed: Jan. 27, 2011

Related U.S. Application Data
(60) Provisional application No. 61/334,633, filed on May 14, 2010.

(51) Int. Cl. H04B 7/00

(52) U.S. Cl. 455/41.2

(57) ABSTRACT

A tractor-trailer PLC apparatus has a BlueTooth RF transceiver coupled to a PLC reader or gateway to communicate PLC data from the tractor and/or trailer through an antenna to a cellular data transceiver in the tractor or trailer for remote communication to an external computer based system.

### CROSS REFERENCE TO CO-PENDING APPLICATIONS

This application claims priority benefit to the filing date of co-pending U.S. Provisional Patent Application Ser. No. 61/334,633 filed on May 14, 2010 in the name of Raymond A. Suda, and entitled Multi-Voltage RFID-PLC Tag, the entire contents of which are incorporated herein by reference.

### BACKGROUND

The transport industry uses a number of tractors with an even larger number of trailers to transport goods cross country, between truck terminals, and/or between container ship terminals and truck terminals and the end customer.

Since it is important to know in such logistical systems which trailer is coupled to which tractor, as well as location of the tractor-trailer and various operational data associated with the tractor and trailer at any time, data communications systems have been developed which transmit tractor and trailer data from the tractor or trailer through cellular, satellite or other RF communication telemetric systems to a remotely located computer host system.

Due to the limited number of existing wires on the cables connecting a tractor to a trailer, power line carrier or PLC systems have been developed which communicate the tractor and trailer data over the power lines of the coupled tractor and trailer. The telemetric unit is typically mounted in the tractor to communicate the PLC data from a PLC reader in the tractor through an antenna to the remote computer host system.

However, the telemetric systems can be expensive when one has to be installed in each of the large number of tractors.

Thus, it would be desireable to provide a PLC tractor-trailer system which can readily use a cellular phone or an iPad or iPad-like tablet computer device with Wi-Fi, 3G or 4G wireless communication capabilities, typically carried by most tractor drivers, for communicating PLC data to a remote computer hosted system.

### SUMMARY

An apparatus for data communication between a tractor and a trailer and a remote terminal includes a power line carrier system coupled to at least one power conductor coupled between a tractor and a trailer for communicating data signals over the at least one power conductor between the tractor and the trailer. A mobile communication terminal carried on one of the tractor and the trailer wirelessly communicates the data carried by the power line carrier system to a remote terminal. The mobile communication terminal includes a cellular data transceiver for communicating via a cellular data network, and a BlueTooth wireless transceiver coupled to the PLC system for wirelessly communicating PLC data signals to the cellular data transceiver.

A method is disclosed for communicating data carried on a tractor-trailer PLC communication system and a remote computer terminal which includes the steps of coupling a BlueTooth transceiver to the tractor-trailer PLC system for wirelessly communicating PLC data signals to a cellular data transceiver in one of the tractor and trailer.

### BRIEF DESCRIPTION OF THE DRAWING

The various features, advantages and other uses of the present will become more apparent by referring to the following detailed description and drawing in which:

FIG. 1 is a pictorial representation of a container chassis monitoring system;

FIG. 2 is a schematic diagram of the RP tag and PLC tractor/trailer communication system shown in FIG. 1;

FIG. 3 is a block diagram of the RP tag system shown in FIG. 2;

FIG. 4 is a schematic diagram of an RP tag-Bluetooth System used in the container chassis monitoring system shown in FIG. 1; and

FIG. 5 is a block diagram of an alternate RP tag-Bluetooth System.

### DETAILED DESCRIPTION

It will be understood that the depiction and description of a chassis-type trailer 12 is by way of example only as that the present tractor trailer data communication apparatus may employ conventional wheeled enclosed or flatbed trailer which is designed for receiving freight which may not be in a portable storage container. It will also be understood that the following description of an RFID tag 20 is by way of example of another type of data generating device on the trailer 12 which generates data which can be communicated through the tractor trailer PLC data communication system.

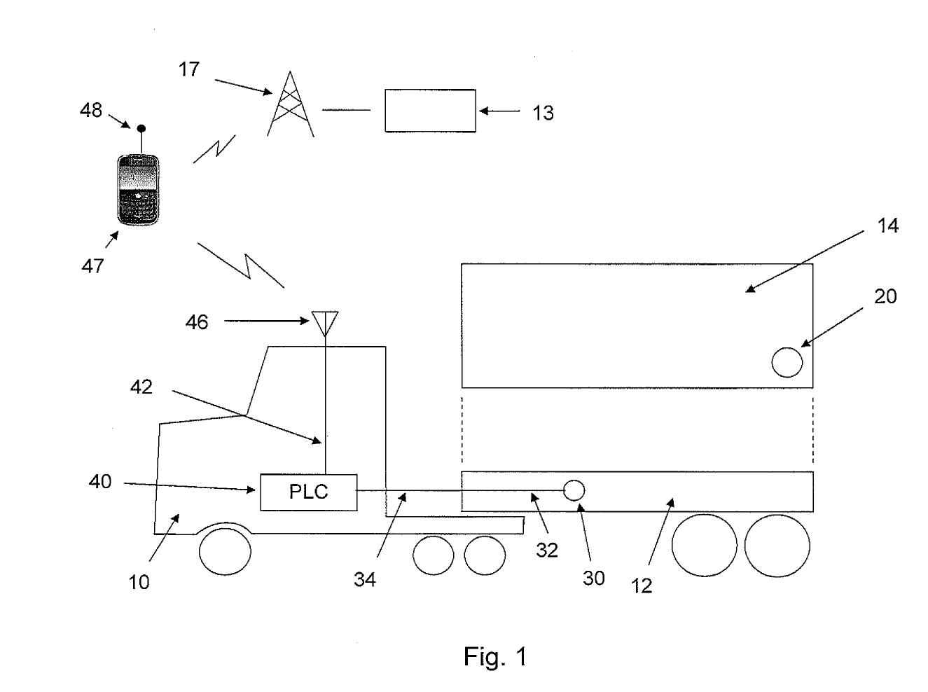

FIG. 1 depicts a container chassis monitoring system. In FIG. 1, a tractor vehicle 10 is depicted along with a chassis-type trailer 12. The chassis-type trailer 12 is configured for removably receiving a freight storage container 14.

An RFID tag 20 is mounted at a suitable location on the container 14. The RFID tag 20 contains a data memory which has been programmed with data identifying the container 14, or its contents, its destination, etc, according to ISO 18000-7 protocols. The RFID tag maybe any available tag, such as an asset tag sold by RFind Systems, Inc., Kelowno, British Columbia, Canada.

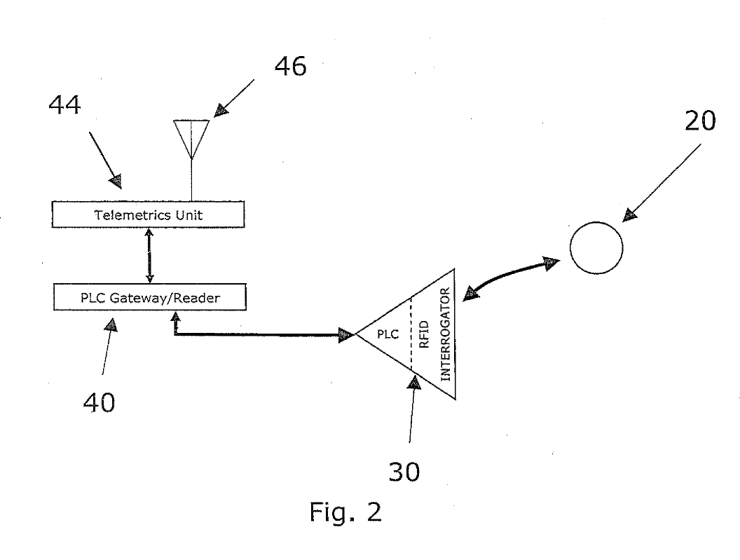

An RP tag 30 is coupled by electrical conductors or wiring 32 on the trailer 12 to power line connectors 34 used to couple and provide power and communications between the electrical systems of the tractor 10 and the trailer 12. The RP tag 30 functions to modulate the data from the RFID tag 20 onto a power line conductor 34 to a PLC reader or mounted in the tractor 10. The PLC gateway 40 typically communicates by hardwire conductors 42 to a telemetrics unit 44. As shown in FIG. 2, the telemetrics unit 44 communicates through an antenna 46 to a satellite, not shown, to communicate the data from the RFID tag 20 to an external host computer-based system.

The telemetrics unit 44 maybe any OBC device using J1708, J1939, J1587, RS232, CanBus USB etc. The telemetric unit 44 can also communicate with the external satellite and computer based host system through cellular, satellite, Wi-Fi, 802 etc., communications.

The telemetrics unit 44 can also have tracking options such as GPS, RFID, RTLS, etc.

Telemetric units 44 are available from a number of companies, including, for example, Qualcomm, GE, International Telemetrics, RTL, Xata, Peoplenet, Skybitz, StarTrak, Partech, Cadec, FleetMind, Turnpike, Navman, etc.

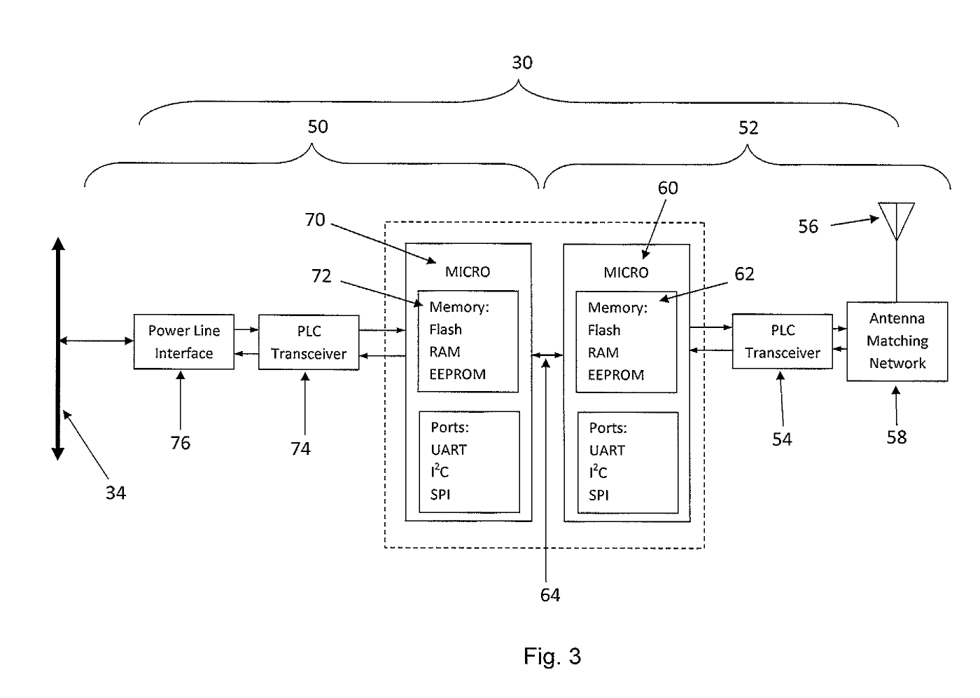

Referring now to FIGS. 2 and 3, the major components of the RP tag 30 are illustrated in block diagram form. The RP tag 30 is formed of two major subsystems, namely, a PLC subsystem 50 and an RFID interrogator system 52.

The RFID interrogator system 52 operates according to ISO 18000-7 protocols for radio frequency identification via active air interface communications at 433.92 MHZ. The interrogator subsystem 52 is a device which communicates with the RFID tag 20 within RF communication range. The interrogator subsystem 52 controls the protocol, reads information from the tag 20, directs the tag 20 to store data in some cases, and insures message delivery and validity.

As shown in FIG. 3, the RFID interrogator subsystem 52 includes a radio transceiver 54, which is coupled to an antenna 56 by an antenna-matching network 58 for wireless communication with the RFID tag 20. The RFID interrogator subsystem 52 includes a processor 60 which accesses one or more types of memory 62 carried in the RP tag 30. The processor 60 is coupled to input and output ports which may be one or more of UART, I²C, or SPI.

The RFID interrogator subsystem 52 communicates with the PLC subsystem 50 via communication path 64.

The PLC subsystem 50 may be a modified PLC system manufactured by Hegemon Electronics, Inc., Sterling Heights Mich. The PLC subsystem 50 functions as a reader to read the data from the RFID tag 20 as obtained and stored in the memory 62 of the RFID interrogator subsystem 52 and transforms the data into a format capable of communication over the existing tractor-trailer power lines 34. Thus, the PLC subsystem 50 includes a -processor 70 which accesses data and a control program stored in one or more memories 72. The PLC subsystem 50 includes the same input and output ports as the RFID interrogator subsystem 52, namely, UART, I²C, or SPI.

The PLC processor 70 communicates through a PLC transceiver 74 and a power line interface 76 to bidirectionally receive and transmit data from the RFID interrogator sub system 52 over the existing tractor-trailer power lines 34 to the PLC reader or gateway 40 mounted in the tractor 10. The PLC gateway 40 can also be a PLC CAN gateway sold by Hegemon Electronics, Inc. The gateway 40 provides a gateway for CAN, RS232, J1708 or J1939 equipped devices to get access to the PLC messages that reside on the tractor and trailer power lines 34. The gateway 40 thus acts as an interface between the telemetrics unit 44 and the RP tag 30 to bidirectionally relay messages from the RP tag 30 to the telemetrics unit 44 and vice versa.

The RP tag 30 coupled with the PLC reader or gateway 40 uniquely enables RFID tags 20 mounted on freight storage containers 14 to be identified along with other data stored in the tag 20, such as the contents of the container 14, and then read and transmitted by the RP tag 30, to the PLC reader or gateway 40 and then to the telemetrics unit 44 for retransmission to a host system remote from the tractor 10. This provides 24/7 monitoring of the container 14 and its contents during transportation to and from the shipping facility and the delivery point.

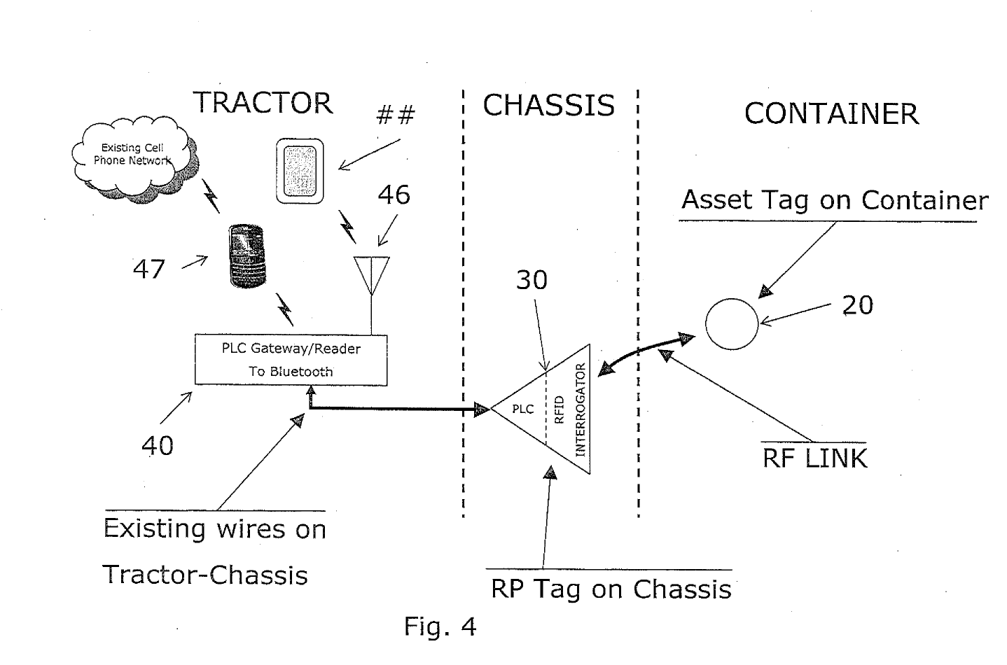

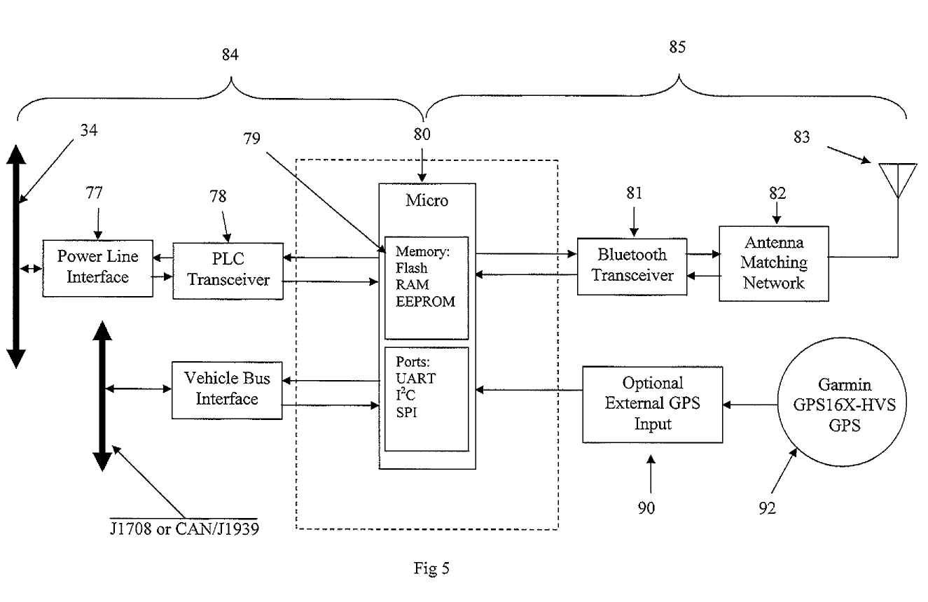

As shown in the alternate aspect depicted in FIGS. 4 and 5, the RP tag 30 functions to modulate the data from the RFID tag 20 onto the power lines 34 to a PLC reader or PLC gateway with a built in BlueTooth RF transceiver 40 mounted in the tractor 10. The unit communicates with a mobile communication terminal or cellular data transceiver, such as a cellular phone 47 or an iPad or iPad-like tablet computer device with Wi-Fi or 3G wireless communication capability, either automatically or by command of cellular phone 47 or unit 40 via radio frequency signals. As shown in FIG. 1, the cellular phone 47 communicates through an antenna 48 to a cellular network or satellite 11 to bi-directionally communicate the data from the RFID tag 20, through the PLC/Bluetooth unit 40 to the external host computer-based system 13. The PLC/BlueTooth unit may also contain interfaces such as J1708, J1939, J1587, RS232,RS485, CanBus, USB etc. for interface to the tractor's data bus. This will allow tractor vehicle information to also be sent to the cellular telephone 47. The cellular telephone unit 47 can also communicate with the external satellite and computer based host system 13 through cellular, satellite, Wi-Fi, 802 etc., communications.

The cellular telephone unit 47 can also have tracking options such as GPS, RFID, RTLS, etc. As optionally shown in FIG. 5, the Bluetooth gateway may have an optional external GPS input 90. An GPS unit 92, such as a Garmin Model No. GPS 16X-HVS, may be used to provide a GPS signal. The output of the external GPS unit 92 is connected to the Bluetooth gateway and sends GPS data to the Bluetooth gateway. This data would then be passed via a vehicle bus interface onto the Bluetooth host device via the Bluetooth connection. The Bluetooth host device, as described above, can be any suitably equipped cellular telephone, iPad or iPad like tablet computer device with Wi-Fi, 3G or 4G wireless communication capability. Such an input allows the tractor operator to obtain real time tracking information at less cost than a traditional truck mounted GPS tracking system. In addition, the tractor driver could use the tablet computer device to enter the information he needs to add data, such as quantity of fuel refills, driver logs, etc. This system could replace the traditional separate keyboard system used in a tractor for entering and seeing data in real time.

Cellular telephone units 47 are available from a number of companies, including, for example, Qualcomm, GE, AT&T, Sprint, Verizon, Motorola, Blackberry, Apple, etc.

The PLC processor 70 and the processor 60 can be merged into one processor.

Referring now to FIGS. 4 and 5, the major components of a PLC Gateway/Reader BlueTooth unit 40 are illustrated in block diagram form.

The PLC Gateway/Reader BlueTooth unit 40 is formed of two major subsystems, namely, a PLC subsystem 84 and an BlueTooth Radio Frequency transceiver system 85. The BlueTooth Radio Frequency transceiver system 85 operates according to industry standard BlueTooth protocols for cellular telephones via active air interface. The BlueTooth Radio Frequency transceiver system 85 is a device which communicates to the cellular telephone 47 or an iPad-like tablet communicating device within RF communication range. The BlueTooth Radio Frequency transceiver subsystem 85 controls the protocol, and sends information to the cellular telephone 47 and insures message delivery and validity.

As shown in FIG. 5, the BlueTooth Radio Frequency transceiver subsystem 85 includes a BlueTooth transceiver 81, which is coupled to an antenna 83 by an antenna matching network 82 for wireless communication with the cellular telephone 47. The BlueTooth Radio Frequency Subsystem 85 includes a processor 80 which accesses one or more types of memory 79 carried in the PLC BlueTooth subsystem or unit 85. The processor 80 is coupled to input and output ports which may be one or more of UART, I²C, SPI, or CAN.

The BlueTooth subsystem 85 communicates with the PLC subsystem 84 through the single shared microprocessor 80.

The PLC subsystem 84 may be a modified PLC system manufactured by Hegemon Electronics, Inc., Sterling Heights Mich. The PLC subsystem 84 functions as a reader to read PLC data from the existing vehicle power conductors 34 obtained and stored in the memory 79 of the processor 80 and transform the data into a format capable of communication over the wireless BlueTooth network. Thus, the PLC subsystem 84 includes a micro-processor 80 which accesses data and a control program stored in one or more memories 79. The PLC subsystem 84 includes the same input and output ports as the BlueTooth subsystem 85, namely, UART, I²C, SPI, or CAN. By use of a processor 80, the BlueTooth subsystem 85 and the PLC subsystem 84 can share data back and forth.

The-processor 80 communicates through a PLC transceiver 78 and a power line interface 77 to bidirectionally receive and transmit data to the BlueTooth subsystem 85 over the BlueTooth network to the Cellular telephone 47 that is either in or near the tractor 10. The PLC BlueTooth unit 40 can also be a PLC CAN gateway sold by Hegemon Electronics, Inc. The gateway 40 provides a gateway for CAN, RS232, J1708 or J1939 equipped devices to get access to the PLC messages that reside on the tractor and trailer power lines 34. The gateway 40 thus acts as an interface between the cellular telephone 47 and the RP tag 30 to bidirectionally rely messages from the RP tag 30 to the cellular telephone 47 and vice versa.

The RP tag 30 coupled with the PLC BlueTooth reader or gateway 40 uniquely enables RFID tags 20 mounted on freight storage containers 14 to be identified along with other data stored in the tag 20 pertaining to the contents of the container 14, and to be read and transmitted by the RP tag 30 and the PLC BlueTooth reader or gateway 40 to the cellular telephone 47 for retransmission to a host system 13 external to and remote from the tractor 10. This provides 24/7 monitoring of the freight storage container 14 and its contents during transportation to and from the ship facility and the delivery point.

What is claimed is:

1. An apparatus for data communication between a coupled tractor and trailer and a remote terminal comprising:
a power line carrier system coupled to at least one power conductor coupled between a tractor and a trailer for communicating data signals over the at least one power conductor between the tractor and the trailer; and
a mobile communication terminal carried on one of the tractor and the trailer for wirelessly communicating data carried by the power line carrier system to the remote terminal, the mobile communication terminal including a cellular data transceiver for communicating via a cellular data network and a BlueTooth wireless transceiver coupled to at least one power conductor for wirelessly communicating data signals to the cellular data transceiver.

2. The apparatus of claim 1 further comprising:
a processor coupled to a memory;
input and output ports accessible by the processor for communicating data to and from the memory and the power line carrier system and the BlueTooth transceiver.

3. The apparatus of claim 2 wherein:
the input and output ports contain at least one of an UART, I²C, SPL and CAN interface.

4. The apparatus of claim 1 wherein:
the BlueTooth transceiver formats the data received from the power line carrier system into BlueTooth format.

5. The apparatus of claim 1 further comprising:
an external GPS input coupled to the power line carrier system for transferring GPS data from an external GPS device to the mobile communication terminal.

6. A method for communicating data carried on a tractor-trailer PLC communication system and a remote computer terminal comprising the step of:
coupling a BlueTooth transceiver to a tractor-trailer PLC system for wirelessly communicating PLC data signals to a cellular data transceiver in one of the tractor and trailer.

7. The method of claim 6 further comprising the step of:
coupling GPS data from an external GPS device to the tractor-trailer PLC system for wirelessly communicating GPS data signals along with the PLC data signals to the data cellular transceiver.
